(19) United States
(12) Patent Application Publication
(10) Pub. No.: US 2025/0259283 A1
(43) Pub. Date: Aug. 14, 2025

(54) ALIGNMENT FOR IMPROVED PERCEPTION BASED ON IMAGE DATA

(71) Applicant: QUALCOMM Incorporated, San Diego, CA (US)

(72) Inventors: Varun RAVI KUMAR, San Diego, CA (US); Debasmit DAS, San Diego, CA (US); Senthil Kumar YOGAMANI, Headford (IE)

(21) Appl. No.: 18/441,969

(22) Filed: Feb. 14, 2024

(51) Int. Cl. G06T 5/80; G06T 7/246; G06T 7/33; G06T 7/50; G06V 20/58; G06V 20/64

(52) U.S. Cl. CPC G06T 5/80; G06T 7/246; G06T 7/337; G06T 7/50; G06V 20/58; G06V 20/647; G06T 2207/10028; G06T 2207/20081; G06T 2207/20084; G06T 2207/20201; G06T 2207/30256; G06T 2207/30261; G06V 2201/08

(57) ABSTRACT

Systems and techniques are described herein for detecting objects. For instance, a method for detecting objects is provided. The method may include generating first image features based on a first image; generating second image features based on a second image; aligning the first image features and the second image features to generate aligned features; estimating motion parameters based on the aligned features; adjusting the aligned features based on the motion parameters to generate adjusted aligned image features; and detecting an object based on the adjusted aligned image features.

### TECHNICAL FIELD

The present disclosure generally relates to perception-based tasks based on image data, such as object detection. For example, aspects of the present disclosure include systems and techniques for aligning image features to improve the performance of perception-based tasks.

### BACKGROUND

Rolling-shutter cameras may capture images one row (or column) at a time. For example, light may impinge on an image sensor of a rolling-shutter camera. The image sensor may include an array of photodetectors arranged as sensor pixels. The rolling-shutter camera may read values from sensor pixels of the image sensor and record the values as an image. The rolling-shutter camera may read and record the pixel values by row (or by column). In cases in which a rolling-shutter camera moves (and/or an object in the scene moves) while an image is being captured, the image may exhibit distortion.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for detecting objects. According to at least one example, a method is provided for detecting objects. The method includes: generating first image features based on a first image; generating second image features based on a second image; aligning the first image features and the second image features to generate aligned features; estimating motion parameters based on the aligned features; adjusting the aligned features based on the motion parameters to generate adjusted aligned image features; and detecting an object based on the adjusted aligned image features.

In another example, an apparatus for detecting objects is provided that includes at least one memory and at least one processor (e.g., configured in circuitry) coupled to the at least one memory. The at least one processor configured to: generate first image features based on a first image; generate second image features based on a second image; align the first image features and the second image features to generate aligned features; estimate motion parameters based on the aligned features; adjust the aligned features based on the motion parameters to generate adjusted aligned image features; and detect an object based on the adjusted aligned image features.

In another example, a non-transitory computer-readable medium is provided that has stored thereon instructions that, when executed by one or more processors, cause the one or more processors to: generate first image features based on a first image; generate second image features based on a second image; align the first image features and the second image features to generate aligned features; estimate motion parameters based on the aligned features; adjust the aligned features based on the motion parameters to generate adjusted aligned image features; and detect an object based on the adjusted aligned image features.

In another example, an apparatus for detecting objects is provided. The apparatus includes: means for generating first image features based on a first image; means for generating second image features based on a second image; means for aligning the first image features and the second image features to generate aligned features; means for estimating motion parameters based on the aligned features; means for adjusting the aligned features based on the motion parameters to generate adjusted aligned image features; and means for detecting an object based on the adjusted aligned image features.

In some aspects, one or more of the apparatuses described herein is, can be part of, or can include an extended reality device (e.g., a virtual reality (VR) device, an augmented reality (AR) device, or a mixed reality (MR) device), a vehicle (or a computing device, system, or component of a vehicle), a mobile device (e.g., a mobile telephone or so-called “smart phone”, a tablet computer, or other type of mobile device), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 includes a diagram and an example image to illustrate issues that can occur with images captured by a rolling-shutter camera;

FIG. 2 illustrates an example system for object detection and/or object tracking, according to various aspects of the present disclosure;

FIG. 3 is a flow diagram illustrating another example process for detecting objects, in accordance with aspects of the present disclosure;

FIG. 4 is a block diagram illustrating an example of a deep learning neural network that can be used to perform various tasks, according to some aspects of the disclosed technology;

FIG. 5 is a block diagram illustrating an example of a convolutional neural network (CNN), according to various aspects of the present disclosure; and

FIG. 6 is a block diagram illustrating an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

As mentioned above, images captured by rolling-shutter cameras may exhibit distortions. Such distortions may affect downstream consumers of such images, such as perception-based tasks. For example, an object detector may be unable to accurately detect and/or track objects based on images exhibiting distortions.

It may be useful for driving systems (e.g., autonomous, semi-autonomous, or assisted driving systems, such as an advanced driver assistance system (ADAS)) of vehicles to have accurate object-detection information. These capabilities may become even more important for higher levels of autonomy, such as autonomy levels 3 and higher. For example, autonomy level 0 requires full control from the driver as the vehicle has no autonomous driving system, and autonomy level 1 involves basic assistance features, such as cruise control, in which case the driver of the vehicle is in full control of the vehicle. Autonomy level 2 refers to semi-autonomous driving, where the vehicle can perform functions, such as drive in a straight path, stay in a particular lane, control the distance from other vehicles in front of the vehicle, or other functions own. Autonomy levels 3, 4, and 5 include much more autonomy. For example, autonomy level 3 refers to an on-board autonomous driving system that can take over all driving functions in certain situations, where the driver remains ready to take over at any time if needed. Autonomy level 4 refers to a fully autonomous experience without requiring a user's help, even in complicated driving situations (e.g., on highways and in heavy city traffic). With autonomy level 4, a person may still remain in the driver's seat behind the steering wheel. Vehicles operating at autonomy level 4 can communicate and inform other vehicles about upcoming maneuvers (e.g., a vehicle is changing lanes, making a turn, stopping, etc.). Autonomy level 5 vehicles fully autonomous, self-driving vehicles that operate autonomously in all conditions. A human operator is not needed for the vehicle to take any action. Thus, autonomous, semi-autonomous, or assisted driving systems are an example of where the systems and techniques described may be employed. Also, the systems and techniques described herein may be employed in non-autonomous (e.g., human controlled) vehicles. For example, the systems and techniques may provide object information to a driver.

One example of distortion caused by rolling-shutter cameras is geometric distortion. For instance, rolling shutter cameras capture images by scanning the image from top to bottom or left to right, resulting in a time-varying distortion (referred to as geometric distortion). Such geometric distortion can cause objects in the scene to appear stretched or compressed, leading to inaccurate object sizes and shapes. Another example of distortion is due to inconsistent exposure. For instance, rolling shutter cameras can result in inconsistent exposure across the image due to the time-varying capture process. Such inconsistent exposure can cause brightness and contrast variations in different parts of the image, leading to difficulties in detecting and tracking objects accurately. Temporal distortion is another example of distortion caused by rolling shutter cameras. For instance, rolling shutter cameras capture images sequentially, which can lead to temporal distortion and misalignment between frames. Temporal distortion can cause errors in object detection (e.g., three-dimensional (3D) object detection), such as for fast-moving objects, scenes with significant camera and/or object motion, and in other scenarios. Motion blur can also lead to distortion. For example, the sequential nature of rolling shutter cameras can result in motion blur in captured images, such as for fast-moving objects, scenes with significant camera or object motion, etc. Motion blur can make it difficult to accurately detect and localize objects in 3D space. Ambiguity in depth perception can also be observed with rolling shutter cameras. For example, rolling shutter cameras can introduce ambiguity in depth perception due to the time delay between different parts of the image. Such ambiguity can lead to inaccurate 3D object detection and localization. Perspective distortion is another issue with rolling shutter cameras. For instance, rolling shutter cameras can introduce perspective distortion due to the non-uniform capture of the scene over time. Perspective distortion can make it challenging to accurately estimate the 3D positions and sizes of objects. Rolling shutter camera issues are also depth dependent (e.g., the depth dependent effect is significantly stronger in the nearby regions of the camera and fade out further away). Such a depth effect can be amplified if the camera lens undergoes large radial and tangential distortion like the fisheye cameras.

Existing techniques rely on a two-step approach, which includes two decoupled steps. The first step includes rolling shutter compensation to undistort the image, which is followed by a perception step (the second step) that generates 3D point clouds to detect objects. However, such a two-step approach leads to 3D depth ambiguity due to the misaligned (noisy) camera extrinsic parameters for the image pixels.

Systems, apparatuses, methods (also referred to as processes), and computer-readable media (collectively referred to herein as “systems and techniques”) are described herein for aligning image features. The systems and techniques described herein may use motion estimation and/or optimal transport for alignment of features to improve perception (e.g., of downstream consumers, such as object detectors). The systems and techniques can correct for rolling-shutter distortion, such as the various distortion examples described above. For example, the systems and techniques may estimate motion parameters (e.g., rotation and translation) of objects in the scene. The systems and techniques can use the motion parameters to warp the distorted image pixels back to their original positions.

For example, an optical flow technique may generate a two-dimensional (2D) motion vector for each pixel of two or more sequential frames. The 2D motion vector may indicate displacement of the pixel between frames. From the pixel-level motion vectors, the overall motion of the camera and/or of the objects in the scene may be estimated. For example, an optical-flow technique (e.g., a Recurrent All-Pairs Field Transforms for Optical Flow (RAFT) algorithm) may be used to estimate the 2D motion vector of each pixel between frames. The 2D motion vectors provide pixel-level motion. The pixel-level motions may be aggregated and techniques like essential matrix decomposition may be used to estimate the 3D rotation and translation parameters of the camera and/or of the objects in the scene. These scene-level motion parameters (rotation, translation) may be used to warp and/or align a distorted image or a distorted 3D point cloud between frames.

For example, an image may be captured using a rolling shutter camera (e.g., over time from top to bottom or left to right). Because the image was captured using a rolling-shutter camera, different parts of the image may represent the scene at slightly different moments in time. The motion parameters (e.g., translation and rotation) capture the motion of the camera/scene during this capture process. By applying the inverse of this motion to each pixel, the systems and techniques can compensate for the time delay and “move” the pixels back to where they would have been if the image was captured instantaneously without a rolling shutter effect.

For example, for each pixel location (x,y) in the distorted image, the systems and techniques can calculate the corresponding location (x′,y′) in the corrected image as:

$$x ' = x + u ( x , y ) y ' = y + v ( x , y )$$

where u and v are the displacement vectors obtained from optical flow/motion parameters at location (x,y).

This warping process aligns all pixels to a single time instant, removing the distortions caused by the sequential capture over time. The output is a corrected perspective view of the scene without rolling shutter effects.

Various aspects of the application will be described with respect to the figures below.

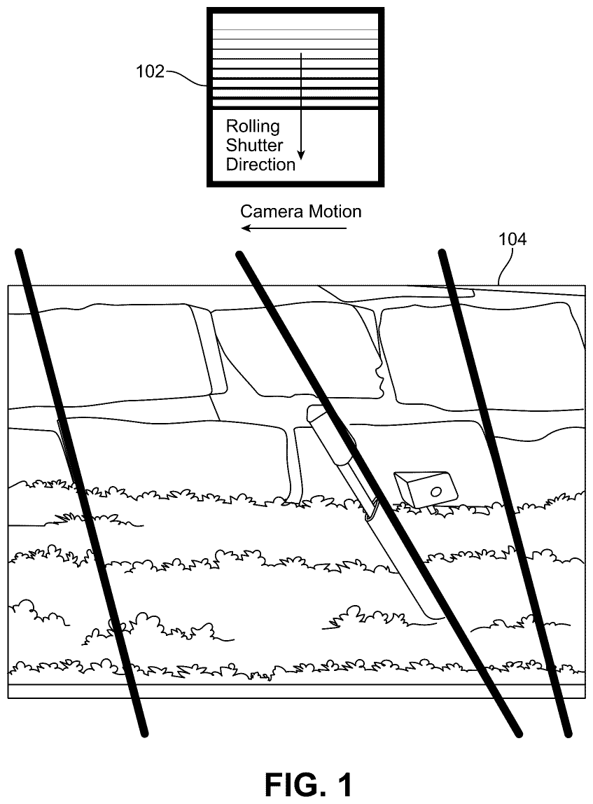

FIG. 1 includes a diagram 102 and an example image 104 illustrating issues that can occur with images captured by a rolling-shutter camera. FIG. 1 includes a diagram 102 illustrating a direction in which pixels of an image may be captured by a rolling-shutter camera and a direction of motion of the rolling-shutter camera while the pixels are being captured. According to the example of diagram 102, the rolling-shutter camera may capture pixels row by row, from a top row to a bottom row. Further, according to the example of diagram 102, the rolling-shutter camera may move from left to right while the image is being captured.

Image 104 is an example image that may be captured according to the example of diagram 102. For example, a topmost pixel representing an object may be captured at a first time. A bottommost pixel representing the object may be captured at a second time. Between the first time and the second time, the camera may have moved (e.g., to the left). Thus, the topmost pixel of the object and the bottommost pixel of the object may be captured at different lateral locations within the image sensor of the camera. Accordingly a vertical object may appear slanted in the captured image.

Rolling-shutter cameras can have a significant impact on the accuracy of object-detection systems. As noted previously, some effects of rolling-shutter cameras on object detection include geometric distortion, inconsistent exposure, temporal distortion, motion blur, ambiguity in depth perception, perspective distortion, and depth-dependent effects.

With regard to geometric distortion, rolling-shutter cameras capture images by scanning the image from top to bottom or left to right, which may result in a time-varying distortion when objects or the camera moves while the image is being captured. This can cause objects in the scene to appear stretched or compressed, leading to inaccurate object sizes and shapes. Image 104 exhibits geometric distortion.

Rolling-shutter cameras can also result in inconsistent exposure across the image due to the time-varying capture process, for example, if the brightness of the scene changes while the image is being captured. This can cause brightness and contrast variations in different parts of the image, leading to difficulties in detecting and tracking objects accurately.

With regard to temporal distortion, rolling-shutter cameras may capture images sequentially (e.g., sequential frames of video data), which can lead to temporal distortion and misalignment between frames. This can cause errors in 3D object detection, particularly for fast-moving objects or scenes with significant camera or object motion.

The sequential nature of rolling shutter cameras can also result in motion blur in the captured images, particularly for fast-moving objects or scenes with significant camera or object motion. This can make it difficult to accurately detect and localize objects in 3D space.

Ambiguity in depth perception is another issue with rolling-shutter cameras. For instance, rolling-shutter cameras can introduce ambiguity in depth perception due to the time delay between different parts of the image. This can lead to inaccurate 3D object detection and localization.

Rolling-shutter cameras can introduce perspective distortion due to the non-uniform capture of the scene over time. This can make it challenging to accurately estimate the 3D positions and sizes of objects.

With regard to depth-dependent effects, the issues of rolling-shutter cameras may also be depth dependent. For example, the effect may be more pronounced in the nearby regions of the ego camera and less pronounced out farther away. For example, objects farther from rolling-shutter camera in image 104 exhibit less geometric distortion than object closer to the rolling-shutter camera. This gets amplified if the camera lens undergoes large radial and tangential distortion like the fisheye cameras.

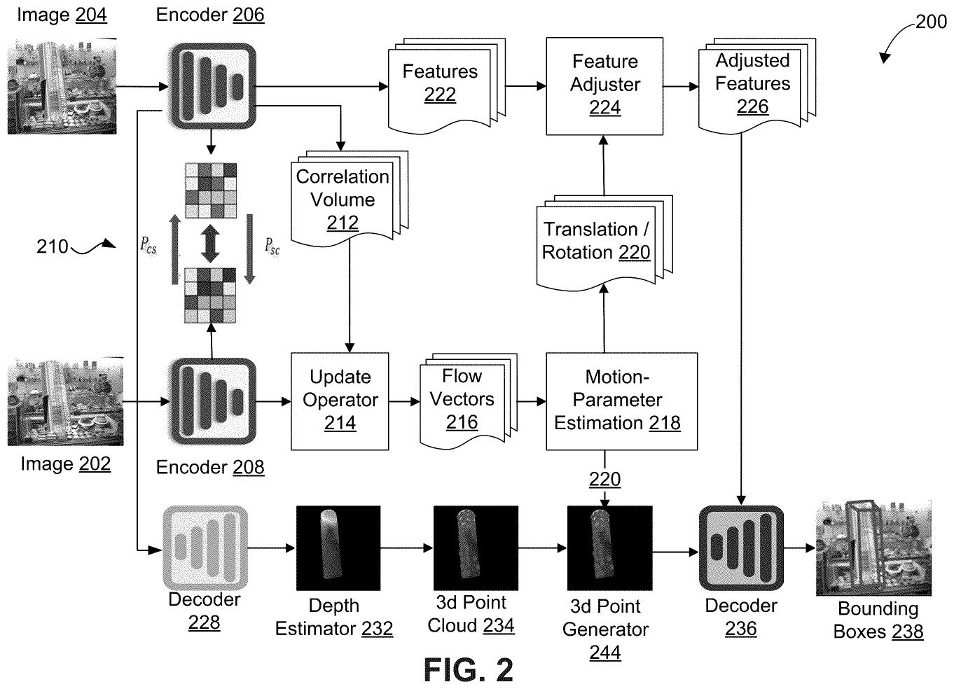

FIG. 2 illustrates an example system 200 for object detection and/or object tracking, according to various aspects of the present disclosure. System 200 includes a two-dimensional (2D) feature-level joint motion estimation and three-dimensional (3D) perception module, which synergizes the depth ambiguity by compensating the effects of a rolling-shutter camera at a perspective view step using point-cloud generation.

Example operations of system 200 of FIG. 2 are described first at a high level. Following the high-level description, additional details are provided with regard to some of the operations and data structures of system 200.

System 200 may obtain an image 202 and an image 204. Image 204 may be captured at a first time (e.g., t-1) and image 202 may be captured at a second time (e.g., t). Image 202 and image 204 may be captured by a rolling-shutter camera and may thus exhibit issues associated with rolling-shutter cameras. For example, rolling-shutter distortion may occur when a camera captures different parts of an image at slightly different times due to the way the sensor scans across the scene.

Encoder 206 of system 200 may encode image 204 to generate features 222. In some cases, encoder 206 can be a feature extractor configured to extract features 222 from the image 204. The feature extractor may be a machine learning system or model, such as a neural network (e.g., a backbone network configured to extract features from images). In one illustrative example, encoder 206 may be, or may include, a convolutional neural network (CNN) trained to generate features based on images (e.g., image 204). Similarly, encoder 208 may encode image 202 to generate features (not labelled in FIG. 2).

As shown in FIG. 2, system 200 may generate a correlation volume 212 (e.g., at alignment 210). In some aspects, system 200 may generate correlation volume 212 by multiplying features 222 with features generated by encoder 208 based on image 202. The features output by the encoder 208 (based on image 202) may have dimensions of H×W×C (e.g., height×width×channels). Features 222 output by the encoder 206 may similarly have dimensions of H×W×C. Correlation volume 212 may be four dimensional and have dimensions of H×W×H×W.

In some cases, system 200 may use an optical-flow technique (e.g., a Recurrent All-Pairs Field Transforms for Optical Flow (RAFT) algorithm) to estimate the motion parameters between image 204 and image 202. The optical-flow technique may calculate optical flow between images (consecutive or non-consecutive images in some cases). The optical flow between images (e.g., between image 204 and image 202) indicates movement of pixels between the images and provides information about the motion in the scene. In some examples, the optical-flow technique can output a flow vector (e.g., an optical flow vector) for one or more pixels (e.g., all pixels or less than all pixels) in a current image, with each flow vector indicating a movement of a pixel between a previous image and the current image. For example, update operator 214 of system 200 may generate flow vectors 216 based on features generated by encoder 208 from image 202 and based on correlation volume 212. Flow vectors 216 may indicate movement between pixels between image 204 and image 202. In some cases, the flow vectors can be included in an optical flow map. The optical flow map can include a two-dimensional (2D) vector field, with each flow vector being a displacement vector showing the movement (e.g., in a horizontal direction and a vertical direction) of points (e.g., pixels) from a first image (e.g., image 204) to a second image (e.g., image 202).

Motion-parameter estimation 218 of system 200 may estimate motion parameters based on flow vectors 216. Translation/rotation 220 may be an example of the estimated motion parameters. Translation/rotation 220 may describe how objects in image 204 are rotated and/or translated between how the objects appear in image 204 and how the objects appear in image 202. Translation/rotation 220 may describe translation according to three degrees of freedom (e.g., according to three perpendicular dimensions, for example, an x-dimension, a y-dimension, and a z-dimension). Translation/rotation 220 may describe rotation according to three degrees of freedom (e.g., according to three rotational axes, such as roll, pitch, and yaw). Motion-parameter estimation 218 may generate translation/rotation 220 using a technique involving decomposing an essential matrix.

The estimated motion parameters (e.g., translation/rotation 220) are employed to correct the rolling shutter distortion in the image. This process aligns the distorted parts of the image to create a corrected perspective view. The motion parameters obtained from the optical-flow technique (e.g., RAFT) are used at a 2D image feature-level. This means that instead of working directly with pixels, system 200 works with higher-level features extracted from the images. This is done for efficiency and to better handle object detection. For example, feature adjuster 224 of system 200 may adjust features 222 based on translation/rotation 220 to generate adjusted features 226. Adjusted features 226 may include features based on image 204, corrected according to translation/rotation 220.

To cause feature-level motion estimates to align with a shared feature encoder, system 200 applies a cross-aligning supervision. This supervision involves aligning the intermediate features extracted from the images using an optimal transport method. For example, at alignment 210, system 200 may align features extracted from image 202 (e.g., by encoder 208) with features extracted from image 204 (e.g., features 222 extracted by encoder 206).

A 3D point cloud is generated from the current camera frame using monocular depth estimation. Monocular depth estimation infers the depth information of the scene from a single 2D image. For example, decoder 228 may decode features 222 (or features based on image 202). Depth estimator 232 may generate 3D point cloud 234 based on the decoded features. In some cases, depth estimator 232 may implement a monocular depth-estimation technique. For example, depth estimator 232 may be, or may include, a machine-learning model trained to generate depth estimates based on a 2D image. 3D point cloud 234 may be, or may include, depth values for pixels in a 2D image (e.g., image 202 or image 204).

System 200 may project the generated 3D point cloud onto the previous camera frame using the motion parameters estimated from the optical flow in the previous time step. This projection helps align the 3D information with the previous frame. For example, 3D point generator 244 of system 200 may project 3D point cloud 234 (generated based on features 222 based on image 204) onto motion parameters (e.g., translation/rotation 220) based on image 202.

System 200 may process the projected 3D point cloud through a 3D object detection decoder. For example, decoder 236 of system 200 may process a 3D point cloud output by the 3D point generator 244. Decoder 236 may identify and/or localize objects in 3D space (e.g., in the 3D point cloud representing the 3D space). Decoder 236 may generate bounding boxes 238 (e.g., 3D bounding boxes) around the objects.

Additional details with regard to some of the operations and data structures of system 200 are now described. For example, update operator 214 of system 200 may estimate the motion parameters (e.g., flow vectors 216) from the rolling shutter distorted images (e.g., image 202 and image 204) using an optical-flow technique. The optical-flow technique may estimate the apparent motion of the image features between consecutive frames (e.g., between image 204 and image 202). The RAFT approach is one example of an optical-flow technique that may be used to obtain the flow estimates of the scene. The flow vector field (e.g., flow vectors 216) between two consecutive frames (e.g., image 204 and image 202) can be represented as:

f(x,y)=[u(x,y), v(x,y)]

where u and v are the horizontal and vertical displacement of each pixel, respectively.

Motion-parameter estimation 218 of system 200 may convert the optical flow (e.g., flow vectors 216) to motion parameters (e.g., translation/rotation 220), such as translation and/or rotation, using camera calibration parameters and a rigid-body motion model. The motion of a rigid body can be represented using a 3D rotation matrix and a 3D translation vector. Given the camera calibration parameters and the rigid-body motion model, the optical flow can be converted to motion parameters. The optical flow may be, or may include, a 2D displacement vector that describes the apparent motion of a point in the image. To ensure efficient correction of rolling shutter effects, the intermediate features may be aligned between the context encoder and share image feature encoder. For the alignment, optimal transport may be used between the features of the context encoder and shared feature encoder. This enable the feature-level motion estimates from optical flow are geometrically aligned with the features extracted by the shared encoder for object detection.

Alignment 210 may be, or may include, feature extraction, vectorization and pooling, optimal transport and score matrix (M), iterative update of M, exponential mapping and probability maps, feature transformation and inverse pooling, and reshaping and inverse pooling.

Feature extraction may be, or may include, generating two types of feature maps, a first generated from a shared encoder (Fs) encoder 206 and a second from a context encoder (Fc) encoder 208. These feature maps have dimensions of Hs×Ws×C and Hc×Wc×C, respectively.

Vectorization and pooling may be, or may include, reshape these feature maps shared encoder feature and context encoder feature into vectors of size Ns×C and Nc×C, respectively, where Ns=[Hs/Ps]×[Ws/Ps] and Nc=[Hc/Ps]×[Wc/Ps]. However, Ns and Nc can be large. So, patches may be used and pooled. Here, Ps represents the size of a patch, pooling may be used to reduce the size of these vectors by obtaining a single value (mean or max) from each patch. Over a patch, a single value is obtained by pooling, which can mean or max. So, the features vectors from the shared and context encoder can be written as fs and fc respectively, which are of sizes Ns×C and Nc×C respectively.

Optimal transport and score matrix (M) may be, or may include, establishing correspondences between fs and fc. A score matrix M of size Ns×Nc can be computed. Each element Mij contains the dot product between the row i of fs and the row j of fc. For that optimal transport theory is used. Essentially, a score matrix M of size Ns×Nc is computed where each element Mij consists of the dot product between row i of fs and row j of fc.

$$Mij = {fs}_{i} * {fc}_{j}$$

For the correspondence, a variable P is considered, which is the same size as M. The goal is to maximize the sum of the Hadamard product between M and P with the constraint that sum of rows and columns equal 1.

Iterative Update of M may be, or may include, using an iterative algorithm to update the score matrix M. For each iteration, the values of rows and columns of M are updated. ri and cj are the ith row and jth column of M, respectively. The update equations involve subtracting logarithmic sums of exponentials with specific constants (A and B) based on the position of the row or column. This process helps refine the correspondences between features.

$$\begin{matrix}ri = ri - log ( \sum exp ( {r}_{ij} - A ) ) where A = log ( Nc ) if i = Ns , else A = 0 \\ cj = cj - log ( \sum exp ( {c}_{ji} - B ) ) where B = log ( Ns ) if j = Nc , else B = 0\end{matrix}$$

Exponential mapping and probability maps may be, or may include, after completing the iterations and obtaining the updated M, performing an exponential mapping (exp(M)) to obtain the probability map P. This probability map P is of size Ns×Nc and is referred to as Psc. The same process is repeated in the reverse direction to obtain another probability map (Pcs) of size Nc×Ns.

Feature transformation and inverse pooling may be, or may include, applying the mapping in the feature space, using the obtained probability maps. For instance, the original shared encoder features (fs) may be transformed using Psc to obtain transformed features (fs′=Psc×fc). Similarly, context encoder features (fc) may be transformed using Pcs to obtain transformed features (fc′=Pcs×fs).

Reshaping and inverse pooling may be, or may include, reshaping the transformed feature vectors fs′ and fc′ back to their original dimensions and are then inverse pooling. This process restores the dimensions and prepares the features for further processing. Finally, the transformed and reshaped features (Fs′ and Fc′) are passed through subsequent layers in your network for further processing, which might include tasks like object detection.

Once the shared encoder features and context encoder features are optimally transported to align with respect to each other (e.g., at alignment 210), they are forward. To convert the transported optical flow features to motion parameters, the 2D displacement vector is converted to a 3D displacement vector using depth information. The depth information is obtained through monocular depth estimation technique (e.g., at depth estimator 232). This can help estimate the 3D motion of the camera between the two frames.

The optical flow is a 2D displacement vector (e.g., flow vectors 216) that describes the apparent motion of a point in the image. To convert the optical flow to motion parameters (e.g., at motion-parameter estimation 218), the 2D displacement vector is converted to a 3D displacement vector using the depth information (e.g., 3D point cloud 234). The depth information can be obtained through monocular depth estimation techniques or other methods (e.g., at depth estimator 232).

Once we the 3D displacement vector is obtained, a rigid-body motion model is used to convert the 3D displacement vector into a 3D translation vector and a 3D rotation matrix (e.g., translation/rotation 220). The translation vector represents the movement of the camera or object in the world coordinate system, while the rotation matrix represents the rotation of the camera or object relative to the world coordinate system.

The steps to convert optical flow to motion parameters using the camera calibration parameters and a rigid body motion model include: converting the 2D optical flow vector to a 3D displacement vector: d=[u, v, 1]*d(z) where u and v are the x and y components of the optical flow vector, d(z) is the depth at the corresponding pixel, and d is the 3D displacement vector.

Motion-parameter estimation 218 of system 200 may convert the 3D displacement vector to a 3D translation vector and a 3D rotation matrix:

R, t=decomposeEssentialMatrix(E)
where R is the 3×3 rotation matrix,
where t is the 3×1 translation vector, and
where E is the essential matrix.

The essential matrix relates the motion of the camera or object between two frames to the optical flow between the frames. The decomposeEssentialMatrix function extracts the rotation and translation parameters from the essential matrix.

The resulting R and t can then be used as the motion parameters, which represent the camera or object motion in 3D space. The motion parameters can be represented as a 3×4 matrix H:H=[R|t] where R is the rotation matrix and t is the translation vector.

A step in generating features for object detection decoder (e.g., decoder 236) is to generate a 3D point cloud (e.g., 3D point cloud 234) from the current camera frame (e.g., image 202). This can be done using a monocular depth approach on camera images with structure from motion (e.g., at depth estimator 232). A 3D point cloud (e.g., 3D point cloud 234) is generated from the current camera frame (e.g., image 202) using monocular depth estimation (e.g., at depth estimator 232) and is then projected onto the previous camera frame (e.g., image 204) using the motion parameters estimated from the optical flow based on the previous time step (e.g., translation/rotation 220 estimated at motion-parameter estimation 218 based on image 202 and image 204). The 3D point cloud features are then passed through to the 3D object detection decoder (e.g., decoder 236).

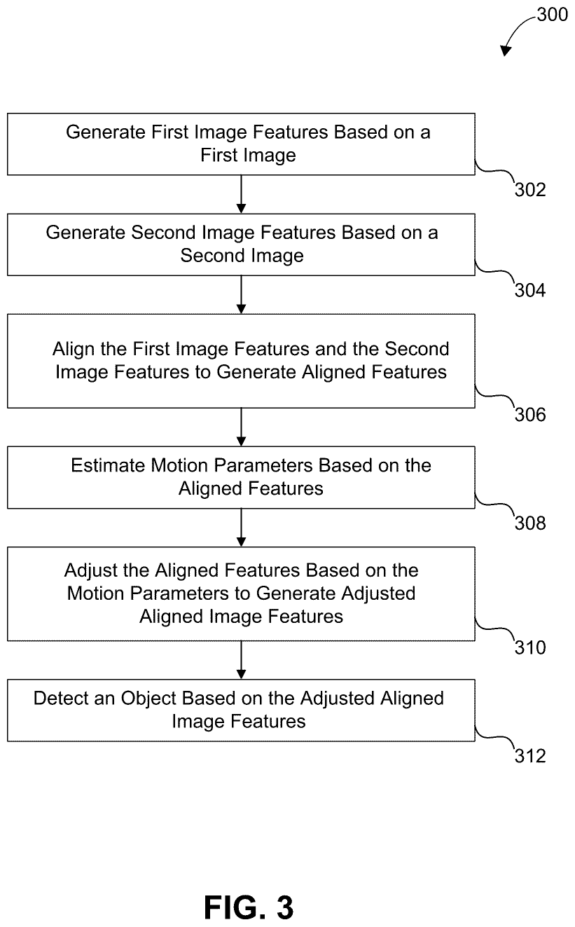

FIG. 3 is a flow diagram illustrating a process 300 for detecting objects, in accordance with aspects of the present disclosure. One or more operations of process 300 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the process 300. The one or more operations of process 300 may be implemented as software components that are executed and run on one or more processors.

At block 302, a computing device (or one or more components thereof) may generate first image features based on a first image. For example, encoder 208 of system 200 of FIG. 2 may generate features based on image 202.

At block 304, the computing device (or one or more components thereof) may generate second image features based on a second image. For example, encoder 206 of system 200 of FIG. 2 may generate features based on image 204.

In some aspects, the first image and the second image may be, or may include, sequential images captured by a rolling-shutter camera.

At block 306, the computing device (or one or more components thereof) may align the first image features and the second image features to generate aligned features. For example, at alignment 210, system 200 may align the features based on image 202 with the features based on image 204.

In some aspects, the computing device (or one or more components thereof) may vectorize and pool the first image features and the second image features. For example, at alignment 210, system 200 may vectorize and pool the image features based on image 202 and the image features based on image 204.

In some aspects, the computing device (or one or more components thereof) may apply transport optimization to determine correspondence between the first image features and the second image features. For example, at alignment 210, system 200 may apply transport optimization to determine a correspondence between the image features based on image 202 and the image features based on image 204.

At block 308, the computing device (or one or more components thereof) may estimate motion parameters based on the aligned features. For example, motion-parameter estimation 218 of system 200 of FIG. 2 may generate, translation/rotation 220, which may be, or may include, motion parameters based on the aligned features.

In some aspects, the computing device (or one or more components thereof) may determine translation-and-rotation parameters based on the motion parameters. The first image features may be adjusted based on the translation-and-rotation parameters. For example, motion-parameter estimation 218 may generate translation/rotation 220 and feature adjuster 224 may adjust image features based on translation/rotation 220.

In some aspects, the motion parameters are estimated using an optical flow technique. For example, motion-parameter estimation 218 may use an optical-flow technique to generate the motion parameters. In some aspects, the motion parameters may be estimated using a recurrent all-pairs field transforms (RAFT) optical-flow technique. For example, motion-parameter estimation 218 may use RAFT to generate the motion parameters.

At block 310, the computing device (or one or more components thereof) may adjust the aligned features based on the motion parameters to generate adjusted aligned image features. For example, feature adjuster 224 of system 200 of FIG. 2 may adjust the aligned features to generate adjusted features 226.

In some aspects, the computing device (or one or more components thereof) may determine depth information based on the first image; determine translation-and-rotation parameters based on the motion parameters; and convert the first image features into a displacement vector based on the depth information and the translation-and-rotation parameters. For example, depth estimator 232 of system 200 of FIG. 2 may determine 3d point cloud 234 based on image features based on image 202 or image features based on image 204. Further, motion-parameter estimation 218 may determine translation/rotation 220 and 3d point generator 244 may convert image features based on image 202 into a displacement vector based on 3d point cloud 234 and translation/rotation 220.

In some aspects, the computing device (or one or more components thereof) may determine a point cloud based on the second image; and project the point cloud onto the first image using the motion parameters. For example, 3D point generator 244 of system 200 may project 3D point cloud 234 (generated based on features 222 based on image 204) onto motion parameters (e.g., translation/rotation 220) based on image 202.

At block 312, the computing device (or one or more components thereof) may detect an object based on the adjusted aligned image features. For example, decoder 236 of system 200 may generate bounding boxes 238 around an object.

In some aspects, to detect the object based on the adjusted aligned image features, the computing device (or one or more components thereof) may process the adjusted aligned image features using a three-dimensional object-detection decoder to generate a bounding box of the object. For example, decoder 236 may process adjusted features 226 to generate bounding boxes 238.

In some aspects, detected object comprises at least one of: a road feature; a street sign; debris; a vehicle; a pedestrian; an animal; a plant; or a structure. For example, decoder 236 may detect a street sign; debris; a vehicle; a pedestrian; an animal; a plant; or a structure.

In some aspects, the computing device (or one or more components thereof) may based on the detected object, at least one of: plan a path of a vehicle; adjust a planned path of the vehicle; predict a path of the object; control the vehicle; or provide information to a driver of the vehicle. For example, the computing device (or one or more components thereof) may be, or may include, an autonomous driving system or advanced driver assistance system (ADAS). The computing device (or one or more components thereof) may plan a path of a vehicle; adjust a planned path of the vehicle; predict a path of the object; control the vehicle; or provide information to a driver of the vehicle.

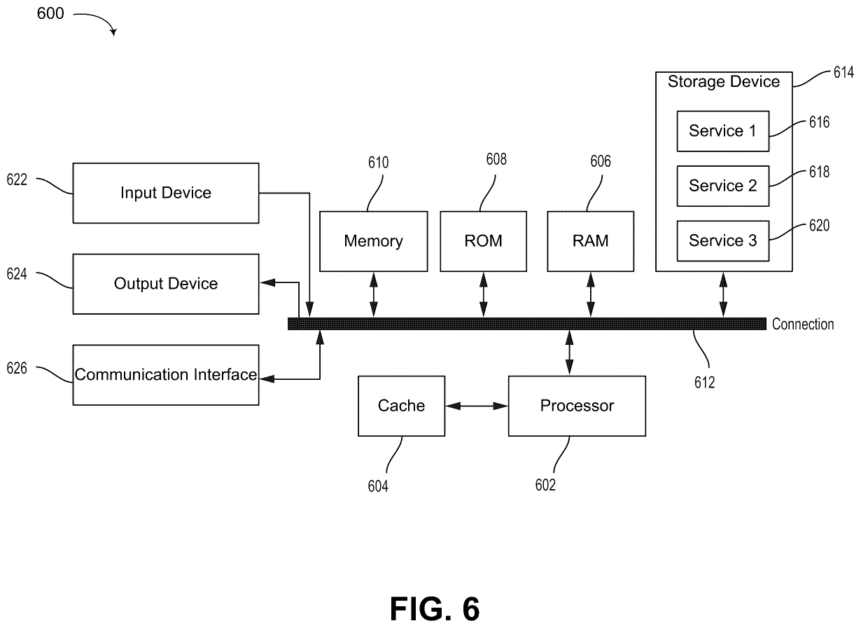

In some examples, as noted previously, the methods described herein (e.g., process 300 of FIG. 3, and/or other methods described herein) can be performed, in whole or in part, by a computing device or apparatus. In one example, one or more of the methods can be performed by system 200 of FIG. 2, or by another system or device. In another example, one or more of the methods (e.g., process 300 of FIG. 3, and/or other methods described herein) can be performed, in whole or in part, by the computing-device architecture 600 shown in FIG. 6. For instance, a computing device with the computing-device architecture 600 shown in FIG. 6 can include, or be included in, the components of the system 200 and can implement the operations of process 300, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 300, and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 300, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

System 200 of FIG. 2 may be included in an automated driver assistance system (ADAS), and/or an autonomous driving system. Additionally or alternatively, an ADAS and/or autonomous driving system may include processors configured to perform process 300 of FIG. 3. For example, a vehicle may include one or more cameras. The cameras may capture images (e.g., image 204 and image 202). The systems and techniques, as implemented in the ADAS or autonomous driving system, may detect and/or track objects in the images. For example, the systems and techniques may detect and/or track objects such as road features, street signs, debris (in the road or beside the road), other vehicles, pedestrians, animals, plants, structure, and/or other objects on or near roads. Further, in some aspects, the systems and techniques, as implemented in the ADAS or autonomous driving system, may adjust an operational parameter of the vehicle. For example, the systems and techniques, as implemented in the ADAS or autonomous driving system, may plan a path of the vehicle, adjust a planned path of the vehicle, predict a path of the object, control the vehicle (e.g., accelerate, brake, turn, etc.), or provide information to a driver of the vehicle (e.g., providing a warning about and/or indicative of the object).

As noted above, various aspects of the present disclosure can use machine-learning models or systems.

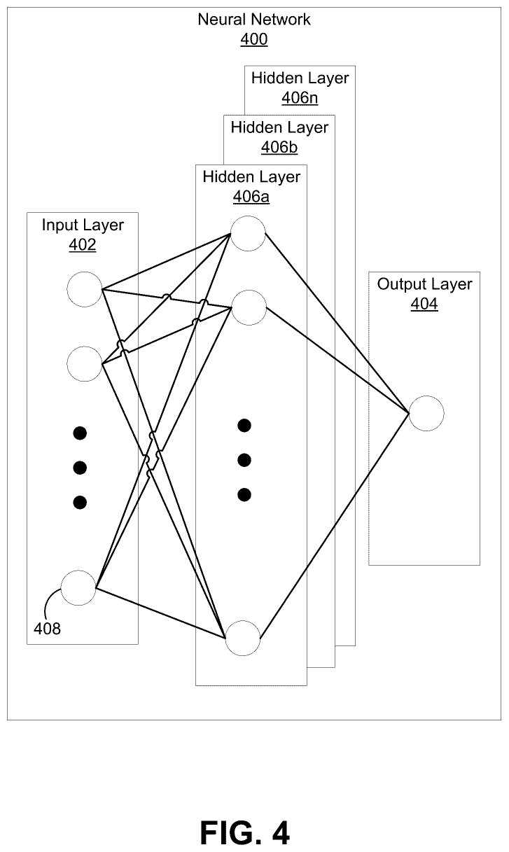

FIG. 4 is an illustrative example of a neural network 400 (e.g., a deep-learning neural network) that can be used to implement machine-learning based feature segmentation, implicit-neural-representation generation, rendering, classification, object detection, image recognition (e.g., face recognition, object recognition, scene recognition, etc.), feature extraction, authentication, gaze detection, gaze prediction, and/or automation. For example, neural network 400 may be an example of, or can implement, encoder 206, encoder 208, decoder 228, and/or decoder 236 of FIG. 2.

An input layer 402 includes input data. In one illustrative example, input layer 402 can include data representing image 202, image 204, features 222, adjusted features 226, and/or decoder 236 of FIG. 2. Neural network 400 includes multiple hidden layers hidden layers 406a, 406b, through 406n. The hidden layers 406a, 406b, through hidden layer 406n include “n” number of hidden layers, where “n” is an integer greater than or equal to one. The number of hidden layers can be made to include as many layers as needed for the given application. Neural network 400 further includes an output layer 404 that provides an output resulting from the processing performed by the hidden layers 406a, 406b, through 406n. In one illustrative example, output layer 404 can provide features 222 and/or bounding boxes 238 of FIG. 2.

Neural network 400 may be, or may include, a multi-layer neural network of interconnected nodes. Each node can represent a piece of information. Information associated with the nodes is shared among the different layers and each layer retains information as information is processed. In some cases, neural network 400 can include a feed-forward network, in which case there are no feedback connections where outputs of the network are fed back into itself. In some cases, neural network 400 can include a recurrent neural network, which can have loops that allow information to be carried across nodes while reading in input.

Information can be exchanged between nodes through node-to-node interconnections between the various layers. Nodes of input layer 402 can activate a set of nodes in the first hidden layer 406a. For example, as shown, each of the input nodes of input layer 402 is connected to each of the nodes of the first hidden layer 406a. The nodes of first hidden layer 406a can transform the information of each input node by applying activation functions to the input node information. The information derived from the transformation can then be passed to and can activate the nodes of the next hidden layer 406b, which can perform their own designated functions. Example functions include convolutional, up-sampling, data transformation, and/or any other suitable functions. The output of the hidden layer 406b can then activate nodes of the next hidden layer, and so on. The output of the last hidden layer 406n can activate one or more nodes of the output layer 404, at which an output is provided. In some cases, while nodes (e.g., node 408) in neural network 400 are shown as having multiple output lines, a node has a single output and all lines shown as being output from a node represent the same output value.

In some cases, each node or interconnection between nodes can have a weight that is a set of parameters derived from the training of neural network 400. Once neural network 400 is trained, it can be referred to as a trained neural network, which can be used to perform one or more operations. For example, an interconnection between nodes can represent a piece of information learned about the interconnected nodes. The interconnection can have a tunable numeric weight that can be tuned (e.g., based on a training dataset), allowing neural network 400 to be adaptive to inputs and able to learn as more and more data is processed.

Neural network 400 may be pre-trained to process the features from the data in the input layer 402 using the different hidden layers 406a, 406b, through 406n in order to provide the output through the output layer 404. In an example in which neural network 400 is used to identify features in images, neural network 400 can be trained using training data that includes both images and labels, as described above. For instance, training images can be input into the network, with each training image having a label indicating the features in the images (for the feature-segmentation machine-learning system) or a label indicating classes of an activity in each image. In one example using object classification for illustrative purposes, a training image can include an image of a number 2, in which case the label for the image can be [0 0 1 0 0 0 0 0 0 0].

In some cases, neural network 400 can adjust the weights of the nodes using a training process called backpropagation. As noted above, a backpropagation process can include a forward pass, a loss function, a backward pass, and a weight update. The forward pass, loss function, backward pass, and parameter update is performed for one training iteration. The process can be repeated for a certain number of iterations for each set of training images until neural network 400 is trained well enough so that the weights of the layers are accurately tuned.

For the example of identifying objects in images, the forward pass can include passing a training image through neural network 400. The weights are initially randomized before neural network 400 is trained. As an illustrative example, an image can include an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

As noted above, for a first training iteration for neural network 400, the output will likely include values that do not give preference to any particular class due to the weights being randomly selected at initialization. For example, if the output is a vector with probabilities that the object includes different classes, the probability value for each of the different classes can be equal or at least very similar (e.g., for ten possible classes, each class can have a probability value of 0.1). With the initial weights, neural network 400 is unable to determine low-level features and thus cannot make an accurate determination of what the classification of the object might be. A loss function can be used to analyze error in the output. Any suitable loss function definition can be used, such as a cross-entropy loss. Another example of a loss function includes the mean squared error (MSE), defined as

$${E}_{total} = \sum \frac{1}{2} {( target - output )}^{2} .$$

The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. Neural network 400 can perform a backward pass by determining which inputs (weights) most contributed to the loss of the network and can adjust the weights so that the loss decreases and is eventually minimized. A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as

$$w = {w}_{i} - η \frac{dL}{dW} ,$$

where w denotes a weight, wᵢ denotes the initial weight, and ρ denotes a learning rate. The learning rate can be set to any suitable value, with a high learning rate including larger weight updates and a lower value indicating smaller weight updates.

Neural network 400 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. Neural network 400 can include any other deep network other than a CNN, such as an autoencoder, a deep belief nets (DBNs), a Recurrent Neural Networks (RNNs), among others.

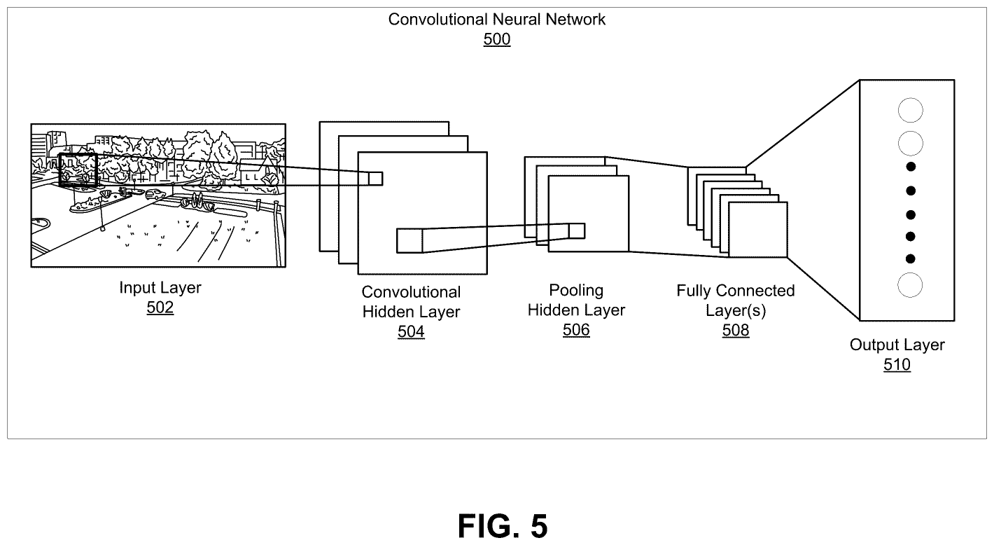

FIG. 5 is an illustrative example of a convolutional neural network (CNN) 500. The input layer 502 of the CNN 500 includes data representing an image or frame. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 504, an optional non-linear activation layer, a pooling hidden layer 506, and fully connected layer 508 (which fully connected layer 508 can be hidden) to get an output at the output layer 510. While only one of each hidden layer is shown in FIG. 5, one of ordinary skill will appreciate that multiple convolutional hidden layers, non-linear layers, pooling hidden layers, and/or fully connected layers can be included in the CNN 500. As previously described, the output can indicate a single class of an object or can include a probability of classes that best describe the object in the image.

The first layer of the CNN 500 can be the convolutional hidden layer 504. The convolutional hidden layer 504 can analyze image data of the input layer 502. Each node of the convolutional hidden layer 504 is connected to a region of nodes (pixels) of the input image called a receptive field. The convolutional hidden layer 504 can be considered as one or more filters (each filter corresponding to a different activation or feature map), with each convolutional iteration of a filter being a node or neuron of the convolutional hidden layer 504. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 504. Each connection between a node and a receptive field for that node learns a weight and, in some cases, an overall bias such that each node learns to analyze its particular local receptive field in the input image. Each node of the convolutional hidden layer 504 will have the same weights and bias (called a shared weight and a shared bias). For example, the filter has an array of weights (numbers) and the same depth as the input. A filter will have a depth of 3 for an image frame example (according to three color components of the input image). An illustrative example size of the filter array is 5×5×3, corresponding to a size of the receptive field of a node.

The convolutional nature of the convolutional hidden layer 504 is due to each node of the convolutional layer being applied to its corresponding receptive field. For example, a filter of the convolutional hidden layer 504 can begin in the top-left corner of the input image array and can convolve around the input image. As noted above, each convolutional iteration of the filter can be considered a node or neuron of the convolutional hidden layer 504. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 504. For example, a filter can be moved by a step amount (referred to as a stride) to the next receptive field. The stride can be set to 1 or any other suitable amount. For example, if the stride is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 504.

The mapping from the input layer to the convolutional hidden layer 504 is referred to as an activation map (or feature map). The activation map includes a value for each node representing the filter results at each location of the input volume. The activation map can include an array that includes the various total sum values resulting from each iteration of the filter on the input volume. For example, the activation map will include a 24×24 array if a 5×5 filter is applied to each pixel (a stride of 1) of a 28×28 input image. The convolutional hidden layer 504 can include several activation maps in order to identify multiple features in an image. The example shown in FIG. 5 includes three activation maps. Using three activation maps, the convolutional hidden layer 504 can detect three different kinds of features, with each feature being detectable across the entire image.

In some examples, a non-linear hidden layer can be applied after the convolutional hidden layer 504. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 500 without affecting the receptive fields of the convolutional hidden layer 504.

The pooling hidden layer 506 can be applied after the convolutional hidden layer 504 (and after the non-linear hidden layer when used). The pooling hidden layer 506 is used to simplify the information in the output from the convolutional hidden layer 504. For example, the pooling hidden layer 506 can take each activation map output from the convolutional hidden layer 504 and generates a condensed activation map (or feature map) using a pooling function. Max-pooling is one example of a function performed by a pooling hidden layer. Other forms of pooling functions be used by the pooling hidden layer 506, such as average pooling, L2-norm pooling, or other suitable pooling functions. A pooling function (e.g., a max-pooling filter, an L2-norm filter, or other suitable pooling filter) is applied to each activation map included in the convolutional hidden layer 504. In the example shown in FIG. 5, three pooling filters are used for the three activation maps in the convolutional hidden layer 504.

In some examples, max-pooling can be used by applying a max-pooling filter (e.g., having a size of 2×2) with a stride (e.g., equal to a dimension of the filter, such as a stride of 2) to an activation map output from the convolutional hidden layer 504. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 504 having a dimension of 24×24 nodes, the output from the pooling hidden layer 506 will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling) and using the computed values as an output.

The pooling function (e.g., max-pooling, L2-norm pooling, or other pooling function) determines whether a given feature is found anywhere in a region of the image and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 500.

The final layer of connections in the network is a fully-connected layer that connects every node from the pooling hidden layer 506 to every one of the output nodes in the output layer 510. Using the example above, the input layer includes 28×28 nodes encoding the pixel intensities of the input image, the convolutional hidden layer 504 includes 3×24×24 hidden feature nodes based on application of a 5×5 local receptive field (for the filters) to three activation maps, and the pooling hidden layer 506 includes a layer of 3×12×12 hidden feature nodes based on application of max-pooling filter to 2×2 regions across each of the three feature maps. Extending this example, the output layer 510 can include ten output nodes. In such an example, every node of the 3×12×12 pooling hidden layer 506 is connected to every node of the output layer 510.

The fully connected layer 508 can obtain the output of the previous pooling hidden layer 506 (which should represent the activation maps of high-level features) and determines the features that most correlate to a particular class. For example, the fully connected layer 508 can determine the high-level features that most strongly correlate to a particular class and can include weights (nodes) for the high-level features. A product can be computed between the weights of the fully connected layer 508 and the pooling hidden layer 506 to obtain probabilities for the different classes. For example, if the CNN 500 is being used to predict that an object in an image is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 510 can include an M-dimensional vector (in the prior example, M=10). M indicates the number of classes that the CNN 500 has to choose from when classifying the object in the image. Other example outputs can also be provided. Each number in the M-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

FIG. 6 illustrates an example computing-device architecture 600 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 600 may include, implement, or be included in system 200. Additionally or alternatively, computing-device architecture 600 may be configured to perform process 300, and/or other process described herein.

The components of computing-device architecture 600 are shown in electrical communication with each other using connection 612, such as a bus. The example computing-device architecture 600 includes a processing unit (CPU or processor) 602 and computing device connection 612 that couples various computing device components including computing device memory 610, such as read only memory (ROM) 608 and random-access memory (RAM) 606, to processor 602.

Computing-device architecture 600 can include a cache of high-speed memory connected directly with, in close proximity to, or integrated as part of processor 602. Computing-device architecture 600 can copy data from memory 610 and/or the storage device 614 to cache 604 for quick access by processor 602. In this way, the cache can provide a performance boost that avoids processor 602 delays while waiting for data. These and other modules can control or be configured to control processor 602 to perform various actions. Other computing device memory 610 may be available for use as well. Memory 610 can include multiple different types of memory with different performance characteristics. Processor 602 can include any general-purpose processor and a hardware or software service, such as service 1 616, service 2 618, and service 3 620 stored in storage device 614, configured to control processor 602 as well as a special-purpose processor where software instructions are incorporated into the processor design. Processor 602 may be a self-contained system, containing multiple cores or processors, a bus, memory controller, cache, etc. A multi-core processor may be symmetric or asymmetric.

To enable user interaction with the computing-device architecture 600, input device 622 can represent any number of input mechanisms, such as a microphone for speech, a touch-sensitive screen for gesture or graphical input, keyboard, mouse, motion input, speech and so forth. Output device 624 can also be one or more of a number of output mechanisms known to those of skill in the art, such as a display, projector, television, speaker device, etc. In some instances, multimodal computing devices can enable a user to provide multiple types of input to communicate with computing-device architecture 600. Communication interface 626 can generally govern and manage the user input and computing device output. There is no restriction on operating on any particular hardware arrangement and therefore the basic features here may easily be substituted for improved hardware or firmware arrangements as they are developed.

Storage device 614 is a non-volatile memory and can be a hard disk or other types of computer readable media which can store data that are accessible by a computer, such as magnetic cassettes, flash memory cards, solid state memory devices, digital versatile disks, cartridges, random-access memories (RAMs) 606, read only memory (ROM) 608, and hybrids thereof. Storage device 614 can include services 616, 618, and 620 for controlling processor 602. Other hardware or software modules are contemplated. Storage device 614 can be connected to the computing device connection 612. In one aspect, a hardware module that performs a particular function can include the software component stored in a computer-readable medium in connection with the necessary hardware components, such as processor 602, connection 612, output device 624, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. An apparatus for detecting objects, the apparatus comprising: at least one memory; and at least one processor coupled to the at least one memory and configured to: generate first image features based on a first image; generate second image features based on a second image; align the first image features and the second image features to generate aligned features; estimate motion parameters based on the aligned features; adjust the aligned features based on the motion parameters to generate adjusted aligned image features; and detect an object based on the adjusted aligned image features.

Aspect 2. The apparatus of aspect 1, wherein the at least one processor is further configured to vectorize and pool the first image features and the second image features.

Aspect 3. The apparatus of any one of aspects 1 or 2, wherein the at least one processor is further configured to apply transport optimization to determine correspondence between the first image features and the second image features.

Aspect 4. The apparatus of any one of aspects 1 to 3, wherein the at least one processor is further configured to determine translation-and-rotation parameters based on the motion parameters, wherein the first image features are adjusted based on the translation-and-rotation parameters.

Aspect 5. The apparatus of any one of aspects 1 to 4, wherein the at least one processor is further configured to: determine depth information based on the first image; determine translation-and-rotation parameters based on the motion parameters; and convert the first image features into a displacement vector based on the depth information and the translation-and-rotation parameters.

Aspect 6. The apparatus of any one of aspects 1 to 5, wherein the at least one processor is further configured to: determine a point cloud based on the second image; and project the point cloud onto the first image using the motion parameters.

Aspect 7. The apparatus of any one of aspects 1 to 6, wherein, to detect the object based on the adjusted aligned image features, the at least one processor is configured to process the adjusted aligned image features using a three-dimensional object-detection decoder to generate a bounding box of the object.

Aspect 8. The apparatus of any one of aspects 1 to 7, wherein the motion parameters are estimated using an optical flow technique.

Aspect 9. The apparatus of any one of aspects 1 to 8, wherein the motion parameters are estimated using a recurrent all-pairs field transforms (RAFT) optical-flow technique.

Aspect 10. The apparatus of any one of aspects 1 to 9, wherein the first image and the second image comprise sequential images captured by a rolling-shutter camera.

Aspect 11. The apparatus of any one of aspects 1 to 10, wherein the detected object comprises at least one of: a road feature; a street sign; debris; a vehicle; a pedestrian; an animal; a plant; or a structure;

Aspect 12. The apparatus of any one of aspects 1 to 11, wherein the at least one processor is further configured to, based on the detected object, at least one of: plan a path of a vehicle; adjust a planned path of the vehicle; predict a path of the object; control the vehicle; or provide information to a driver of the vehicle.

Aspect 13. A method for detecting objects, the method comprising: generating first image features based on a first image; generating second image features based on a second image; aligning the first image features and the second image features to generate aligned features; estimating motion parameters based on the aligned features; adjusting the aligned features based on the motion parameters to generate adjusted aligned image features; and detecting an object based on the adjusted aligned image features.

Aspect 14. The method of aspect 13, further comprising vectorizing and pooling the first image features and the second image features.

Aspect 15. The method of any one of aspects 13 or 14, further comprising applying transport optimization to determine correspondence between the first image features and the second image features.

Aspect 16. The method of any one of aspects 13 to 15, further comprising determining translation-and-rotation parameters based on the motion parameters, wherein the first image features are adjusted based on the translation-and-rotation parameters.

Aspect 17. The method of any one of aspects 13 to 16, further comprising: determining depth information based on the first image; determining translation-and-rotation parameters based on the motion parameters; and converting the first image features into a displacement vector based on the depth information and the translation-and-rotation parameters.

Aspect 18. The method of any one of aspects 13 to 17, further comprising: determining a point cloud based on the second image; and projecting the point cloud onto the first image using the motion parameters.

Aspect 19. The method of any one of aspects 13 to 18, wherein detecting the object based on the adjusted aligned image features comprises processing the adjusted aligned image features using a three-dimensional object-detection decoder to generate a bounding box of the object.

Aspect 20. The method of any one of aspects 13 to 19, wherein the motion parameters are estimated using an optical flow technique.

Aspect 21. The method of any one of aspects 13 to 20, wherein the motion parameters are estimated using a recurrent all-pairs field transforms (RAFT) optical-flow technique.

Aspect 22. The method of any one of aspects 13 to 21, wherein the first image and the second image comprise sequential images captured by a rolling-shutter camera.

Aspect 23. The method of any one of aspects 13 to 22, further comprising, based on the detected object, adjusting an operational parameter of a vehicle.

Aspect 24. The method of any one of aspects 13 to 23, wherein the detected object comprises at least one of: a road feature; a street sign; debris; a vehicle; a pedestrian; an animal; a plant; or a structure;

Aspect 25. The method of any one of aspects 13 to 24, further comprising, based on the detected object, at least one of: planning a path of a vehicle; adjusting a planned path of the vehicle; predicting a path of the object; controlling the vehicle; or providing information to a driver of the vehicle.

Aspect 26. The apparatus of any one of aspects 1 to 12, wherein the at least one processor is further configured to, based on the detected object, adjust an operational parameter of a vehicle.

Aspect 27. A non-transitory computer-readable storage medium having stored thereon instructions that, when executed by at least one processor, cause the at least one processor to perform operations according to any of aspects 13 to 25.

Aspect 28. An apparatus for providing virtual content for display, the apparatus comprising one or more means for perform operations according to any of aspects 13 to 25.

What is claimed is:

1. An apparatus for detecting objects, the apparatus comprising:
at least one memory; and
at least one processor coupled to the at least one memory and configured to:
generate first image features based on a first image;
generate second image features based on a second image;
align the first image features and the second image features to generate aligned features;
estimate motion parameters based on the aligned features;
adjust the aligned features based on the motion parameters to generate adjusted aligned image features; and
detect an object based on the adjusted aligned image features.

2. The apparatus of claim 1, wherein the at least one processor is further configured to vectorize and pool the first image features and the second image features.

3. The apparatus of claim 1, wherein the at least one processor is further configured to apply transport optimization to determine correspondence between the first image features and the second image features.

4. The apparatus of claim 1, wherein the at least one processor is further configured to determine translation-and-rotation parameters based on the motion parameters, wherein the first image features are adjusted based on the translation-and-rotation parameters.

5. The apparatus of claim 1, wherein the at least one processor is further configured to:
determine depth information based on the first image;
determine translation-and-rotation parameters based on the motion parameters; and
convert the first image features into a displacement vector based on the depth information and the translation-and-rotation parameters.

6. The apparatus of claim 1, wherein the at least one processor is further configured to:
determine a point cloud based on the second image; and
project the point cloud onto the first image using the motion parameters.

7. The apparatus of claim 1, wherein, to detect the object based on the adjusted aligned image features, the at least one processor is configured to process the adjusted aligned image features using a three-dimensional object-detection decoder to generate a bounding box of the object.

8. The apparatus of claim 1, wherein the motion parameters are estimated using an optical flow technique.

9. The apparatus of claim 1, wherein the motion parameters are estimated using a recurrent all-pairs field transforms (RAFT) optical-flow technique.

10. The apparatus of claim 1, wherein the first image and the second image comprise sequential images captured by a rolling-shutter camera.

11. The apparatus of claim 1, wherein the at least one processor is further configured to, based on the detected object, adjust an operational parameter of a vehicle.

12. The apparatus of claim 11, wherein the detected object comprises at least one of:
a road feature;
a street sign;
debris;
a vehicle;
a pedestrian;
an animal;
a plant; or
a structure.

13. A method for detecting objects, the method comprising:
generating first image features based on a first image;
generating second image features based on a second image;
aligning the first image features and the second image features to generate aligned features;
estimating motion parameters based on the aligned features;
adjusting the aligned features based on the motion parameters to generate adjusted aligned image features; and
detecting an object based on the adjusted aligned image features.

14. The method of claim 13, further comprising vectorizing and pooling the first image features and the second image features.

15. The method of claim 13, further comprising applying transport optimization to determine correspondence between the first image features and the second image features.

16. The method of claim 13, further comprising determining translation-and-rotation parameters based on the motion parameters, wherein the first image features are adjusted based on the translation-and-rotation parameters.

17. The method of claim 13, further comprising:
determining depth information based on the first image;
determining translation-and-rotation parameters based on the motion parameters; and
converting the first image features into a displacement vector based on the depth information and the translation-and-rotation parameters.

18. The method of claim 13, further comprising:
determining a point cloud based on the second image; and
projecting the point cloud onto the first image using the motion parameters.

19. The method of claim 13, further comprising, based on the detected object, adjusting an operational parameter of a vehicle.

20. The method of claim 19, wherein the detected object comprises at least one of:
a road feature;
a street sign;
debris;
a vehicle;
a pedestrian;
an animal;
a plant; or
a structure.
